(19) United States
(12) Patent Application Publication
(10) Pub. No.: US 2002/0004385 A1
(43) Pub. Date: Jan. 10, 2002

(54) MOBILE TELEPHONE PROVIDED WITH CALL TRANSFER FUNCTION AND CALL TRANSFER METHOD

(76) Inventors: MASAHIRO YAMAMOTO, KAWASAKI-SHI (JP); YUICHI ABE, KAWASAKI-SHI (JP)

Correspondence Address: HELGOTT & KARAS, EMPIRE STATE BUILDING, 60TH FLOOR, NEW YORK, NY, 10118

(21) Appl. No.: 09/211,154

(22) Filed: Dec. 14, 1998

(30) Foreign Application Priority Data
Jul. 2, 1998 (JP) HEI 10-187233

(51) Int. Cl. H04M 3/42

(52) U.S. Cl. 455/417; 379/211.01

(57) ABSTRACT

A mobile telephone having a call transfer function for transferring a received call to a telephone designated in advance. The telephone to which a call is to be transferred is registered in a memory, and when the mobile telephone is connected to an external apparatus, the mobile telephone requests a mobile communication network to start a call transfer service, while when the connection between the mobile telephone and the external apparatus is cut off, the mobile telephone requests the network to stop the service.

### BACKGROUND OF THE INVENTION

1. Field of the Invention

The present invention relates to a mobile telephone provided with a call transfer function and a call transfer method and, more particularly, to a mobile telephone provided with a call transfer function and a call transfer method for transferring a received call to a telephone designated in advance.

2. Description of the Related Art

In a call transfer service for transferring a received call to a telephone registered in advance, the registration of the telephone to which a call is to be transferred, and the procedure for starting or stopping the transfer service are executed by directly operating a telephone by the contractor of the call transfer service. For example, the registration of a telephone to which a call is to be transferred (hereinafter sometimes referred to merely as ‘transferred telephone registration’), and the procedure for starting or stopping the transfer service (hereinafter sometimes referred to merely as ‘transfer start’ and ‘transfer stop’) are executed by using a mobile telephone which is capable of transferring a call in accordance with the flows shown in FIGS. 15 to 17. In order to register a telephone to which a call is to be transferred, the special service code allotted to ‘transferred telephone registration’ is dialled (step 110), as shown in FIG. 15. The audio response message for confirming the telephone (“The telephone to which a call is transferred is xxxx, isn't it? The telephone is registered”) from the mobile communication network is then received (step 102). Thereafter, the communication with the mobile communication network is cut off (step 103). In order to start the transfer service, the special service code allotted to the ‘transfer start’ is dialled (step 111), as shown in FIG. 16. The audio response message for reporting the start (“The transfer service is started.”) from the mobile communication network is then received (step 112). Thereafter, the communication with the mobile communication network is cut off (step 113). In order to stop the transfer service, the special service code allotted to the ‘transfer stop’ is dialled (step 121), as shown in FIG. 17. The audio response message for reporting the stop (“The transfer service is stopped.”) from the mobile communication network is then received (step 122). Thereafter, the communication with the mobile communication network is cut off (step 123).

FIG. 18 shows the sequence executed between a mobile telephone 1 and a mobile communication network 2 at the time of registering a telephone to which a call is to be transferred, and instructing the start or stop of the call transfer service.

When a telephone to which a call is to be transferred is registered, or the start or stop of the transfer service is instructed by pushing buttons, the mobile telephone 1 transmits an originating radio state report message to the mobile communication network 2. The mobile communication network 2 then determines a speech channel and establishes synchronism with each other by transmitting and receiving synchronous bursts to and from each other. When synchronism is established, the mobile telephone 1 transmits a setup message to the mobile communication network 2 and the mobile communication network 2 receives a setup request. When the setup message is (1) the registration of a telephone to which a call is to be transferred, it consists of “the special service code for ‘transferred telephone registration’+the number of a telephone to which a call is to be transferred”, when it is (2) the instruction for starting the transfer service, it consists of ‘the special service code for ‘transfer start’”, and when it is (3) the instruction for stopping the transfer service, it consists of “the special service code for ‘transfer stop’”.

The mobile communication network 2 executes the authentication procedure, and if the result of authentication is normal, and the mobile telephone 1 is a telephone which is under contract for a transfer service, the processing corresponding to ‘transferred telephone registration’, ‘transfer start’ or ‘transfer stop’ is executed. For example, when the setup message is ‘transferred telephone registration’, the mobile communication network 2 stores the number of the telephone to which a call is to be transferred in correspondence with the number of the mobile telephone 1. When the setup message is ‘transfer start’, the mobile communication network 2 turns on a transfer flag, while when it is ‘transfer stop’, the mobile communication network 2 turns off the transfer flag (turns on a transfer stop flag). Thereafter, the mobile communication network 2 transmits an audio response message (for confirming the telephone to which a call is to be transferred/reporting the start of the transfer service/ or reporting the stop of the transfer service) to the mobile telephone 1, and cuts off the speech channel with the mobile telephone 1.

The above-described sequence is executed when the registration of a telephone to which a call is to be transferred, or the start or stop of transfer service is requested from the mobile telephone which is under contract for a transfer service. It is also possible to request ‘transferred telephone registration’, ‘transfer start’ or ‘transfer stop’ by using another telephone which is not under contract. In this case, the special service code is not dialled, but the number of the service control center which is designated in advance as the agency for receiving a request for the transfer service is dialled. FIG. 19 is an explanatory view of the procedure for ‘transferred telephone registration’, ‘transfer start’ or ‘transfer stop’ executed by using another telephone.

The number of the service control center for receiving a request for the transfer service is first dialled (step 201). The number of the mobile telephone which is to receive the service is then input (step 202). The service control center transmits the audible response message for requesting the identification number (step 203), whereby the identification number is input. The service control center compares the input identification number with the identification number which has been registered in advance in correspondence with the number of the mobile telephone (step 204), if both identification numbers do not coincide, the service control center cuts off the line (step 205). On the other hand, if both identification numbers coincide, the service control center transmits the audio response message for instructing the mobile telephone to input the special service number corresponding to ‘transferred telephone registration’, ‘transfer start’ or ‘transfer stop’ (step 206). If the special service number corresponding to ‘transferred telephone registration’ is input the service control center transmits the audio response message for instructing the mobile telephone to input the number of a telephone to which a call is to be transferred. Thereby, the mobile telephone inputs the number of the telephone to which a call is to be transferred in accordance with the response message for requesting it (steps 207 to 209). After the response message for confirming the telephone to which a call is to be transferred is received (step 210), the line is cut off (step 205). In the case of requesting ‘transfer start’ or ‘transfer stop’, the special service number corresponding these services is input at the step 207.

As described above, in the related art, ‘transferred telephone registration’, ‘transfer start’ or ‘transfer stop’ is requested by directly telephoning the telecommunication company by the user of a mobile telephone. Therefore, if a call is received and transmitted to a home telephone when the user is at home, it is necessary for the user to request the telecommunication company to start the transfer service every time the user comes back home, and to request the telecommunication company to stop the transfer service every time the user leaves home. Not only is such a ‘start transfer or ‘transfer stop’ operation is cumbersome and inconvenient, but also there is a possibility of forgetting the operation. Additionally, the reason why a call is transferred to the home telephone when the user is at home is that a fixed telephone at home is superior in the sound quality to a mobile telephone, and that since all calls are received at home, they are convenient to deal with.

In addition, some users want a call to be transferred to a fixed telephone (on the desk) in the office when they are in the office and to be transferred to a fixed telephone at home when they are at home. In such a case, it is necessary to change the number of a telephone to which a call is to be transferred depending upon the place they are in, so that the operation becomes further cumbersome.

Recently, the use of a portable telephone during driving a car has become a social problem. It is desirable not to use a portable telephone during driving. Therefore, the mode of the portable phone is switched to a transfer mode during driving and when a call is received by the phone, it is transferred to a telephone to which a call is to be transferred. For this purpose, however, it is necessary for the user to request ‘transfer start’ before driving a car, and ‘transfer stop’ when leaving the car. This is also cumbersome.

### SUMMARY OF THE INVENTION

Accordingly, it is an object of the present invention to eliminate the above-described problems in the related art and to provide a mobile telephone and a call transfer method which are capable of starting and stopping a call transfer service by a simple operation.

It is another object of the present invention to provide a mobile telephone and a call transfer method which are capable of changing the number of a telephone to which a call is to be transferred and staring and stopping a call transfer service by a simple operation.

It is still another object to provide a mobile telephone and a call transfer method which are capable of starting and stopping a call transfer service by a simple operation even outside of the service area in which the mobile telephone cannot be used.

It is a further object of the present invention to provide a mobile telephone and a call transfer method which are capable of starting and stopping a call transfer service by a simple operation without the need for adding an equipment or changing the call transfer system or the transfer protocol on the network side.

To achieve these objects, in a first aspect of the present invention, there is provided a mobile telephone having a call transfer function which is capable of transferring a received call to a telephone designated in advance, the mobile telephone comprising: a detector for detecting that an external apparatus such as a battery charger is connected to the mobile telephone; and a call transfer controller for requesting a mobile communication network to start a call transfer service for transferring a received call to the telephone designated in advance when the external apparatus is connected. In this case, the telephone to which a call is to be transferred is registered in advance in a memory of the mobile telephone or the external apparatus. The call transfer controller requests the mobile communication network to stop the call transfer service when the connection between the external apparatus and the mobile telephone is cut off. In this manner, it is possible to instruct the start of the call transfer service only by mounting the mobile telephone on, for example, the battery charger and the stop of the service only by removing the mobile telephone from the battery charger.

In a second aspect of the present invention, there is provided a mobile telephone having a call transfer function which is capable of transferring a received call to a telephone designated in advance, the mobile telephone comprising: an external apparatus identification unit for identifying an external apparatus such as a battery charger which is connected to the mobile telephone; and a call transfer controller for obtaining a telephone which is registered in advance in correspondence with the external apparatus when the external apparatus is connected, and requesting the mobile communication network to start a call transfer service for transferring a received call to the telephone obtained.

In this case, the number of the telephone to which a call is to be transferred is stored in advance in a memory of the mobile telephone or the external apparatus. The call transfer controller requests the network to stop the call transfer service when the connection between the external apparatus and the mobile telephone is cut off. In this manner, it is possible to instruct the start of the call transfer service to the fixed telephone, for example, at home only by mounting the mobile telephone on the battery charger for the home telephone, and the start of the call transfer service to the fixed telephone in the office only by mounting the mobile telephone on the battery charger for the telephone in the office. It is also possible to instruct the stop of the service only by removing the mobile telephone from the battery charger.

In a third aspect of the present invention, there is provided a call transfer method comprising the steps of: registering a telephone to which a call is to be transferred in a memory; requesting the mobile communication network to start a call transfer service for transferring a received call to the registered telephone to which a call is to be transferred when an external apparatus is connected to the mobile telephone; and requesting the network to stop the call transfer service when the connection between the external apparatus and the mobile telephone is cut off. In this case, the telephones to which a call is to be transferred are registered in the memory in correspondence with the external apparatuses. The mobile telephone identifies the external apparatus connected to the mobile telephone, obtains the corresponding telephone to which a call is to be transferred from the memory, and requests the mobile communication network to start the transfer service to the telephone to which a call is to be transferred. If the communication between the mobile telephone and the mobile communication network is impossible, the mobile telephone requests the connected external apparatus to execute the procedure for starting the transfer service, whereby the external apparatus requests the mobile communication network to start the transfer service to the registered telephone to which a call is to be transferred. In this manner, it is possible to start and stop the transfer service by a simple operation without the need for adding an apparatus to the network or changing the call transfer system or the transfer protocol. In addition, the registration of a telephone to which a call is to be transferred, and the operation of starting or stopping the transfer service are possible even when the mobile telephone cannot be used because of the location outside of the service area or due to the regulation on radio waves. Furthermore, when a call is received by the mobile telephone, it is possible to talk with the caller via the fixed telephone to which the call is transferred.

Other features and advantages of the present invention will be apparent from the following description taken in conjunction with the accompanying drawings.

### BRIEF DESCRIPTION OF THE DRAWINGS

FIG. 1 schematically shows the structure of a first embodiment of the present invention;

FIGS. 2A to 2C show the structures of examples of a detector for detecting that an external apparatus is connected to the mobile telephone;

FIG. 3 shows the structure of the first embodiment of a mobile telephone according to the present invention;

FIG. 4 is a flowchart of ‘transferred telephone registration’, ‘transfer start’ and ‘transfer stop’ processes in the present invention;

FIG. 5 schematically shows the structure of a second embodiment of the present invention;

FIG. 6 shows the structure of an external apparatus identification unit;

FIG. 7 shows the structure of the second embodiment a mobile telephone according to the present invention;

FIG. 8 is flowchart of ‘transferred telephone registration’, ‘transfer start’ and ‘transfer stop’ processes in the second embodiment;

FIG. 9 shows the structure of a modification of the second embodiment of the present invention;

FIGS. 10A and 10B are explanatory views of communication interfaces;

FIG. 11A is an explanatory view of the format of an up serial signal;

FIG. 11B is an explanatory view of the format of a down serial signal;

FIG. 12 is an explanatory view of the communication sequence between a mobile telephone and an external apparatus;

FIG. 13 schematically shows the structure of a third embodiment of the present invention;

FIG. 14 is a flowchart of ‘transferred telephone registration’, ‘transfer start’ and ‘transfer stop’ processes in the third embodiment;

FIG. 15 is a flowchart of a ‘transferred telephone registration’ process in a conventional mobile telephone;

FIG. 16 is a flowchart of a ‘transfer start’ process in the conventional mobile telephone;

FIG. 17 is a flowchart of a ‘transfer stop’ process in the conventional mobile telephone;

FIG. 18 is an explanatory view of the procedures for ‘transferred telephone registration’, ‘transfer start’ and ‘transfer stop’ in the conventional mobile telephone; and

FIG. 19 is an explanatory view of the procedures for ‘transferred telephone registration’, ‘transfer start’ and ‘transfer stop’ executed by using another telephone.

### DESCRIPTION OF THE PREFERRED EMBODIMENTS

### (A) First Embodiment

### (a) Summary

In a first embodiment, when an external apparatus such as a battery charger is connected to a mobile telephone, the mobile telephone automatically executes the procedure for registering a telephone to which a call is to be transferred and starting the call transfer service. When the external apparatus is removed, the mobile telephone automatically executes the procedure for stopping the call transfer service. In this manner, it is possible to instruct the start of the call transfer service only by mounting the mobile telephone on, for example, the battery charger and the stop of the service only by removing the mobile telephone from the battery charger.

### (b) Schematic Structure

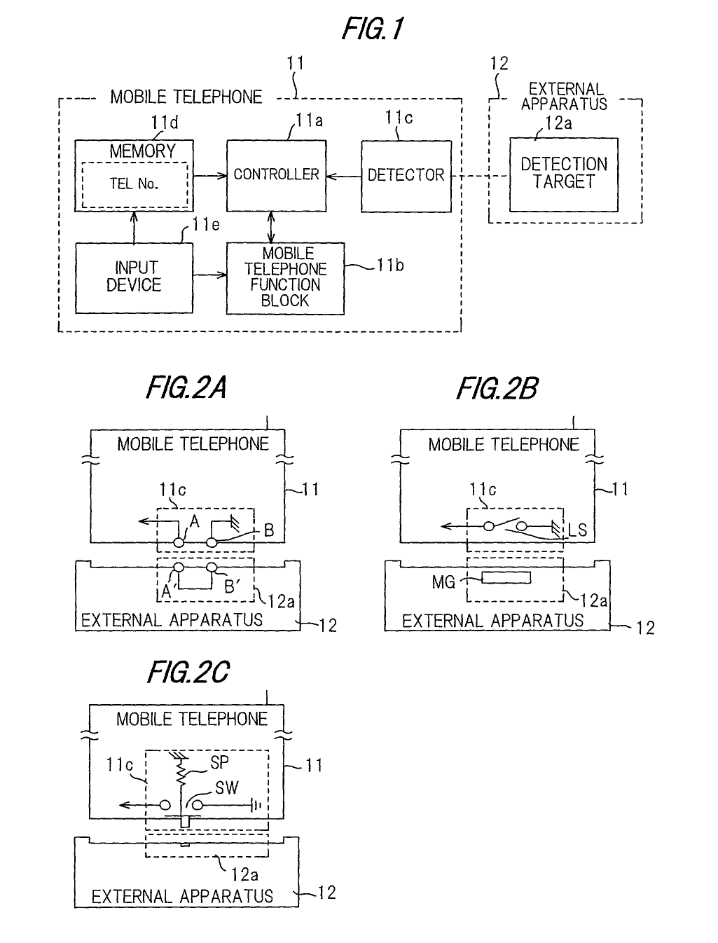

FIG. 1 schematically shows the structure of the first embodiment of the present invention. Only one external apparatus is adopted. In FIG. 1, the reference numeral 11 represents a mobile telephone and 12 an external apparatus such as a battery charger connected to the mobile telephone 11. In the mobile telephone 11, the reference numeral 11a represents a controller, 11b a block provided with the function of a conventional mobile telephone, 11c a detector for detecting whether or not the external apparatus is connected, 11d a memory for storing a number of a telephone to which a call is to be transferred, and 11e an input device for inputting the number of the telephone to which a call is to be transferred to be stored in the memory 11d. The external apparatus 12 is provided with a detection target 12a for making the detector 11c detect the connection of the external apparatus 12.

FIGS. 2A to 2C show the structures of examples of the detector 11c. In FIGS. 2A to 2C, the reference numeral 11 represents the mobile telephone, 12 a battery charger as the external apparatus, 11c the detector, and 12a the detection target. In FIG. 2A, when the mobile telephone 11 is mounted on the battery charger 12, the terminals A, B of the detector 11c come into contact with the terminals A′, B′ of the detection target 12a, thereby short-circuiting between the terminals A and B. When the mobile telephone 11 is removed from the battery charger 12, the circuit between the terminals A and B is cut off. It is therefore possible to detect whether or not the external apparatus 12 is connected from the short circuit or cut-off between the terminals A and B. In FIG. 2B, when the mobile telephone 11 is mounted on the battery charger 12, a lead switch LS of the detector 11c is turned on by a magnet MG of the detection target 12a, while when the mobile telephone 11 is removed from the battery charger 12, the lead switch LS is turned off. It is therefore possible to detect whether or not the external apparatus 12 is connected from the ON/OFF of the lead switch LS. In FIG. 2C, when the mobile telephone 11 is mounted on the battery charger 12, the protrusion of a switch SW of the mobile telephone 11 is pushed into the bottom of the battery charger 12, thereby turning on the switch SW. When the mobile telephone 11 is removed from the battery charger 12, the switch SW is turned off by the elastic force of a spring SP. It is therefore possible to detect whether or not the external apparatus 12 is connected from the ON/OFF of the switch SW.

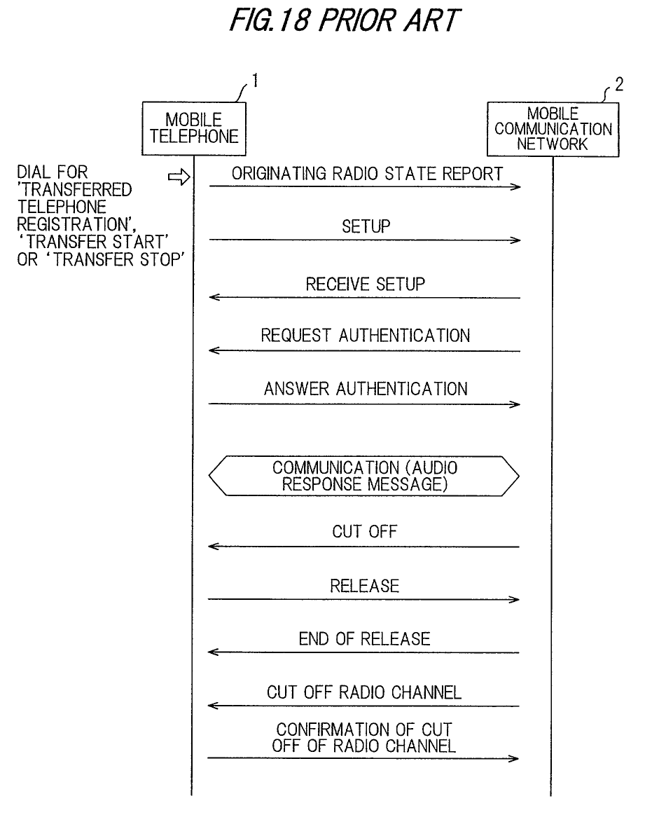

In FIG. 1, when the external apparatus 12 is connected to the mobile telephone 11, the controller 11a detects that the external apparatus 12 is connected by the cooperation of the detector 11c and the detection target 12a. The controller 11a which has detected the connection of the external apparatus 12 reads the number of the telephone to which a call is to be transferred from the memory 11d and controls the block 11b which has the function of a conventional mobile telephone so as to automatically execute the procedure for ‘transferred telephone registration’ and ‘transfer start’ in accordance with the procedure shown in FIG. 18. When the mobile telephone 11 is removed from the external apparatus 12, the controller 11a detects that the external apparatus 12 has been removed owing to the detector 11c, and controls the block 11b which has the function of a conventional mobile telephone so as to automatically execute the procedure for ‘transfer stop’ in accordance with the procedure shown in FIG. 18.

### (c) Detailed Structure of the Mobile Telephone

The mobile telephone 11 is generally provided with an input device, a memory and a controller. Therefore, the controller, the memory and the input device in the mobile telephone function block 11b can also be served as the controller 11a, the memory 11d and the input device 11e shown in FIG. 1.

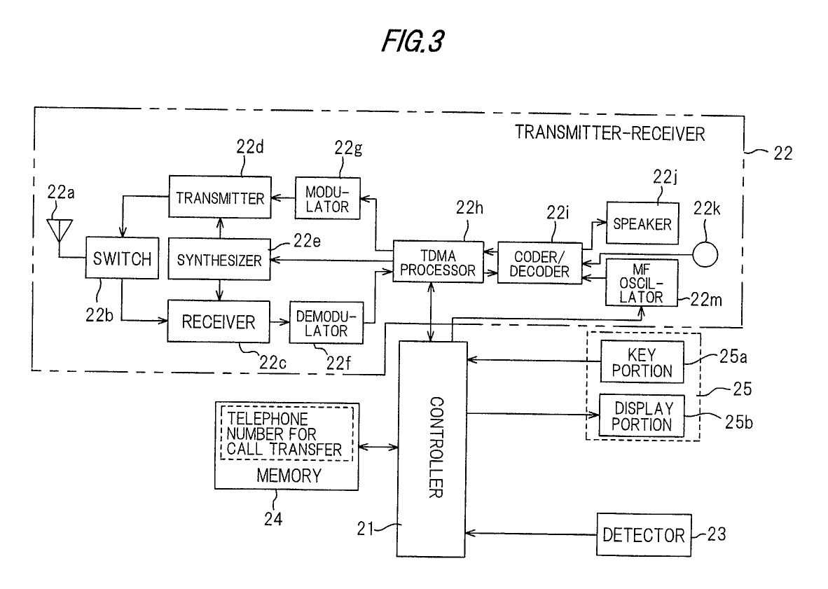

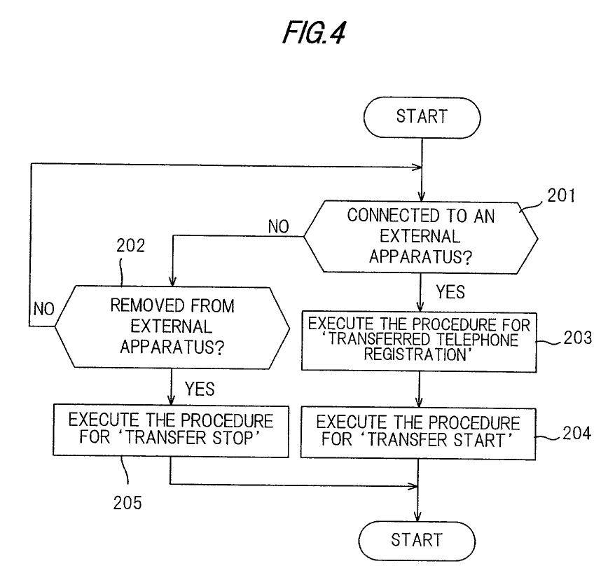

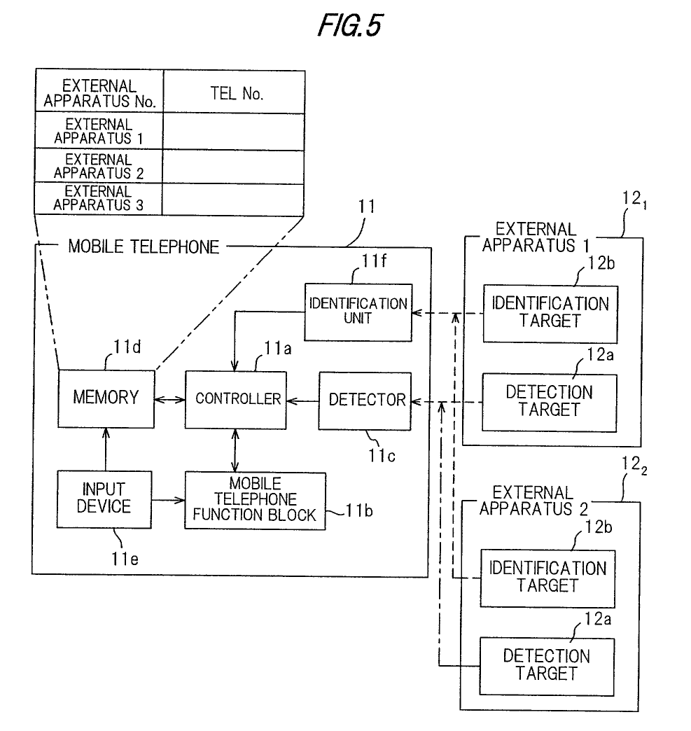

FIG. 3 shows the detailed structure of the first embodiment of a mobile telephone according to the present invention. In FIG. 3, the reference numeral 21 represents a controller for controlling the entire part of the mobile telephone, 22 a transmitter-receiver of the mobile telephone, 23 a detector for detecting whether or not the external apparatus is connected, 24 a memory for storing the number of the telephone to which a call is to be transferred or the like, 25 an operating portion including a key portion 25a and a display portion 25b. The key portion 25a is used when the telephone number of a called party is input to call the called party, or the number of a telephone to which a call is to be transferred is input.

In the transmitter-receiver 22, the reference numeral 22a denotes an antenna, 22b a duplexer for appropriately switching the antenna 22a between a transmitter and a receiver, 22c the receiver, 22d the transmitter, 22e a synthesizer for outputting a predetermined frequency signal corresponding to a control channel or a speech channel, 22f a demodulator for demodulating digital data, 22g a modulator for modulating digital data, and 22h a TDMA processor for extracting and outputting data (control data, PCM voice data) from a predetermined time slot when the data is received, and inserting data into a predetermined time slot when the data is transmitted. The reference numeral 22i denotes a coder/decoder for converting received PCM voice data into analog signals and converting analog voice signals or PB signals (MF signals) into digital signals. The reference numeral 22j represents a speaker, 22k a microphone, and 22m an MF signal oscillator for transmitting any of the numbers 0 to 9 and the symbols * and # in the form of a combination of two frequency signals. The mobile telephone of the present invention is not restricted to a digital TDMA system.

### (d) ‘Transferred Telephone Registration’, ‘Transfer Start’ and ‘Transfer Stop’ Processes

FIG. 4 is a flowchart of the ‘transferred telephone registration’, ‘transfer start’ and ‘transfer stop’ processes of the controller 21.

Whether or not the external apparatus is connected to the mobile telephone is checked (step 201), and if the external apparatus is not connected, whether or not the external apparatus has been removed is checked (step 202). If the external apparatus has not been removed, the steps 201 and thereafter are repeated.

When the connection of the external apparatus is detected at the step 201, the controller 21 assumes that the special service code for ‘transferred telephone registration’ and the number of a telephone to which a call is to be transferred have been input, and automatically executes the ‘transferred telephone registration’ process in accordance with the procedure shown in FIG. 18 (step 203). As the number of the telephone to which a call is to be transferred, the number which has been stored in the memory 24 in advance by operating the key portion 25a is used.

The controller 21 then automatically executes the ‘transfer start’ process in accordance with the procedure shown in FIG. 18 (step 204), and the process is returned to the start. In this manner, the calls reached to the mobile telephone thereafter are transferred to the telephone to which a call is to be transferred.

On the other hand, if the detector 23 detects that the external apparatus is not connected at the step 202, the controller 21 assumes that the special service code for ‘transfer stop’ has been input, and automatically executes the ‘transfer stop’ process (step 205) in accordance with the procedure shown in FIG. 18, and the process is returned to the start. In this manner, the transfer service is stopped thereafter.

### (e) Modification

As the external apparatus, various types of external apparatuses such as those of an insertion type and a mounting type may be adopted. However, it is preferable to use the battery charger for the mobile telephone as the external apparatus. It is generally the case that a mobile telephone and its battery charger are so designed as to enable the connection therebetween to be detected. It is therefore possible to regard the battery charger of a mobile telephone as the external apparatus and to easily realize a mobile telephone which is capable of automatically executing the procedure for ‘transferred telephone registration’ and ‘transfer start’ when the mobile telephone is mounted on the battery charger, and automatically executing the ‘transfer stop’ process when the mobile telephone is removed from the battery charger. That is, it is possible to start the call transfer service only by mounting the mobile telephone on the battery charger, and stop the service only by removing it.

In the above explanation, the number of a telephone to which a call is to be transferred is stored in the memory of the mobile telephone. Alternatively, it is possible to adopt the structure in which the number of the telephone to which a call is to be transferred is stored in a memory of the external apparatus and the number of the telephone to which a call is to be transferred is obtained from the external apparatus when executing the ‘transferred telephone registration’ process.

### (B) Second Embodiment

### (a) Summary

In a second embodiment, a plurality of external apparatuses are prepared. When one of them is connected to a mobile telephone, the mobile telephone automatically executes the procedure for registering a telephone to which a call is to be transferred corresponding to the external apparatus and the procedure for starting the call transfer service. When the external apparatus is removed, the mobile telephone automatically executes the procedure for stopping the call transfer service. In this manner, it is possible to instruct the start of the call transfer service to the fixed telephone, for example, at home only by mounting the mobile telephone on the battery charger for the home telephone, and the start of the call transfer service to the fixed telephone in the office only by mounting the mobile telephone on the battery charger for the telephone in the office. It is also possible to stop the transfer service only by removing the mobile telephone from the battery charger.

### (b) Schematic Structure

When a plurality of external apparatuses are used, (1) the mobile telephone stores the correspondence between each external apparatus and the number of a telephone to which a call is to be transferred, and obtains the appropriate number of the telephone to which a call is to be transferred by identifying the external apparatus connected to the mobile telephone, or (2) each external apparatus stores the number of a telephone to which a call is to be transferred and when an external apparatus is connected to the mobile telephone, it transmits the number of the telephone to which a call is to be transferred to the mobile telephone.

FIG. 5 schematically shows the structure of a second embodiment. In this embodiment, there are a plurality of external apparatuses, and the mobile telephone stores the correspondence between each external apparatus and the number of a telephone to which a call is to be transferred. In FIG. 5, the reference numeral 11 represents a mobile telephone, and 12₁, 12₂ first and second external apparatuses such as battery chargers connected to the mobile telephone 11. In the mobile telephone 11, the reference numeral 11a represents a controller, 11b a block provided with the function of a conventional mobile telephone, 11c a detector for detecting whether or not an external apparatus is connected, 11d a memory for storing a number of a telephone to which a call is to be transferred in correspondence with each external apparatus, 11e an input device for inputting the number of a telephone to which a call is to be transferred, to the memory 11d, and 11f an identification unit for identifying a connected external apparatus.

In each of external apparatuses 12₁, 12₂, the reference numeral 12a represents a detection target for making the detector 11c detect the connection of the external apparatus 12₁ (12₂), and 12b an identification target for making the identification unit 11f identify the external apparatus 12₁ (12₂). The detector 11c and the detection target 12a have the structure shown in FIGS. 2A to 2C. The identification unit 11f and the identification target 12b can be constituted by a combination of a lead switch and a magnet.

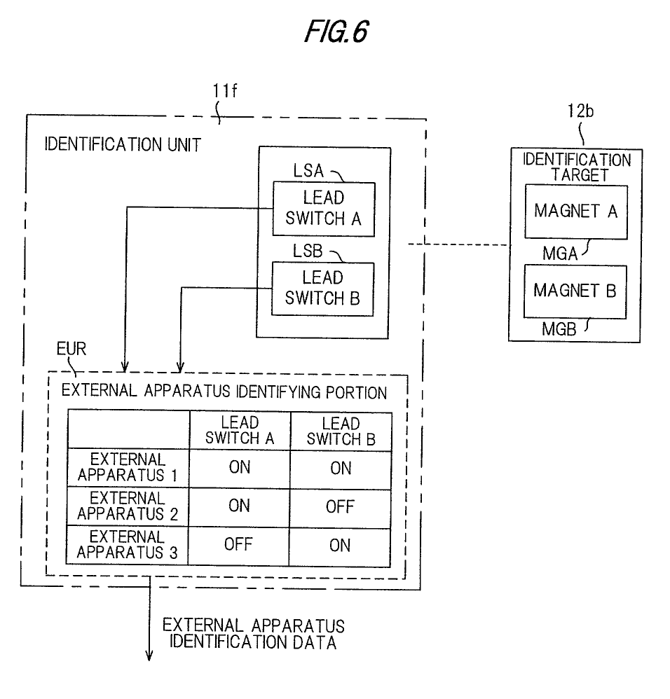

FIG. 6 shows the structure of the external apparatus identification unit 11f. The identification unit 11f is provided with an external apparatus identifying portion EUR for identifying a connected external apparatus in accordance with a combination of ON and OFF of two lead switches LSA, LSB. The identification target 12b of an external apparatus is provided with magnets MGA, MGB for turning on the lead switches LSA, LSB, respectively, as occasion demands. For example, (1) an external apparatus 1 is provided with both magnets MGA and MGB, (2) an external apparatus 2 is provided with only one magnet MGA, and (3) an external apparatus 3 is provided with only one magnet MGB. In this manner, when the mobile telephone 11 is connected to one of the external apparatuses 1 to 3, the lead switches LSA, LSB are turned on or off, as shown in the table in FIG. 6. The external apparatus identifying portion EUR can identify the connected external apparatus from the ON/OFF state of the lead switches LSA, LSB and inputs the external apparatus identification data (“11” for the external apparatus 1, “10” for the external apparatus 2, “01” for the external apparatus 3) to the controller 11a. The controller 11a can recognize that an external apparatus is connected when the lead switch LSA or LSB of the external apparatus is turned on, so that it is possible to dispense with the detector 11c and the detection target 12a.

In FIG. 5, when a first or second external apparatus 12₁ or 12₂ is connected to the mobile telephone 11, the controller 11a detects that the external apparatus is connected by the cooperation of the detector 11c and the detection target 12a. The controller 11a also obtains the identification data of the connected external apparatus by the cooperation of the identification unit 11f and the identification target 12b.

When the controller 11a obtains the identification data of the connected external apparatus, it reads the number of a telephone to which a call is to be transferred corresponding to the external apparatus by reference to the table of the memory 11d, and automatically executes the procedure for ‘transferred telephone registration’ and ‘transfer start’ by controlling the block 11b having the function of the conventional mobile telephone in accordance with the procedure shown in FIG. 18. When the mobile telephone 11 is removed from the external apparatus 12₁ or 12₂, the controller 11a detects that the external apparatus has been removed by the cooperation of the detector 11c and the detection target 12a, and automatically executes the procedure for ‘transfer stop’ by controlling the block 11b having the function of the conventional mobile telephone in accordance with the procedure shown in FIG. 18.

### (c) Detailed Structure of a Mobile Telephone

The mobile telephone 11 is generally provided with an input device, a memory and a controller. Therefore, the controller, the memory and the input device in the mobile telephone function block 11b can also be served as the controller 11a, the memory 11d and the input device 11e shown in FIG. 5.

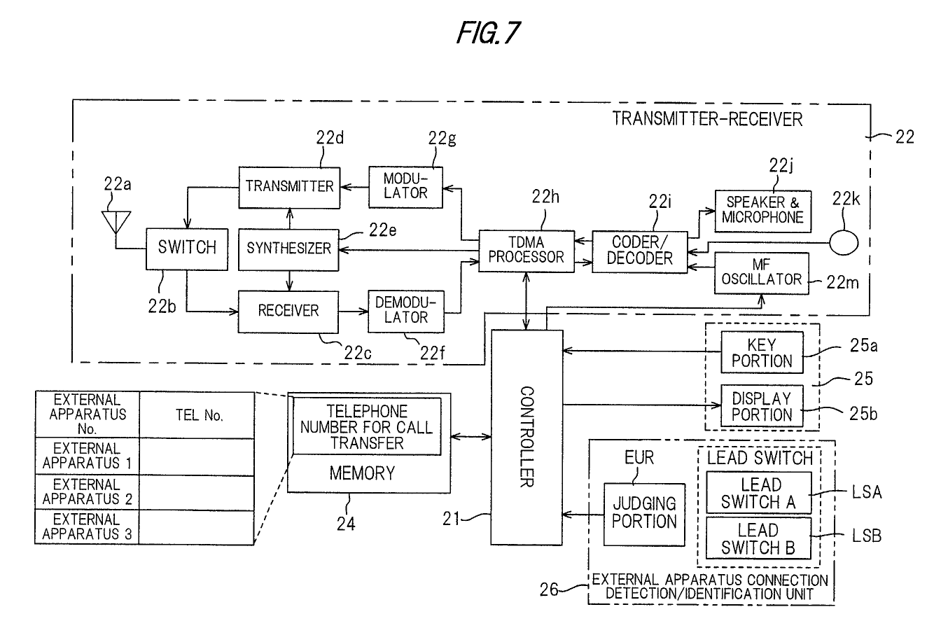

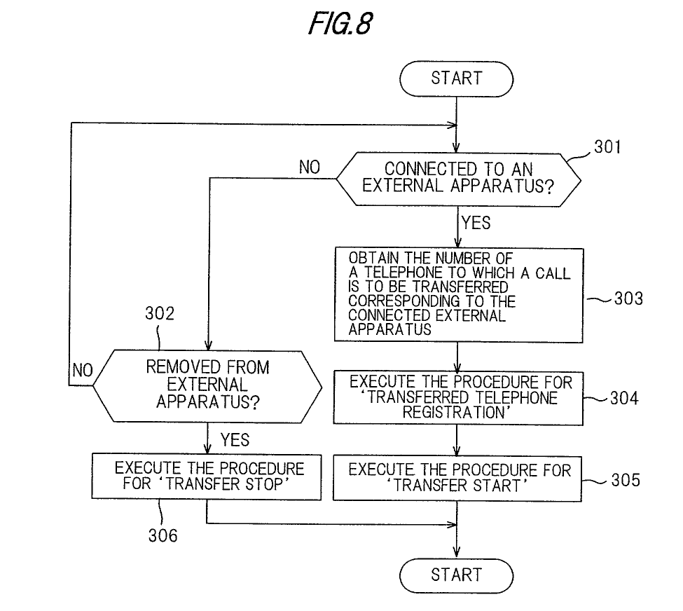

FIG. 7 shows the detailed structure of the second embodiment of a mobile telephone according to the present invention. In FIG. 7, the reference numeral 21 represents a controller for controlling the entire part of the mobile telephone, 22 a transmitter-receiver of the mobile telephone having the same structure shown in FIG. 3, 24 a memory for storing the number of a telephone to which a call is to be transferred in correspondence with each external apparatus, 25 an operating portion including a key portion 25a and a display portion 25b. The key portion 25a is used when the number of a called party is input to call the called party or the correspondence between a number of a telephone to which a call is to be transferred and an external apparatus is input. The reference numeral 26 denotes an external apparatus connection detection/identification unit for detecting the connection or disconnection of an external apparatus and identifying the connected external apparatus.

In the external apparatus connection detection/identification unit 26, the symbols LSA and LSB denote lead switches, and EUR a judging portion for (1) judging that an external apparatus is connected when either of the lead switches LSA and LSB is turned on, and (2) identifying the connected external apparatus in accordance with the combination of the ON/OFF of the lead switched LSA and LSB. The mobile telephone of the present invention is not restricted to a digital TDMA system.

### (d) ‘Transferred Telephone Registration’, ‘Transfer Start’ and ‘Transfer Stop’ Processes

FIG. 8 is a flowchart of the ‘transferred telephone registration’, ‘transfer start’ and ‘transfer stop’ processes of the controller 21.

Whether or not the external apparatus is connected to the mobile telephone is checked (step 301), and if the external apparatus is not connected, whether or not the external apparatus has been removed is checked (step 302). If the external apparatus has not been removed, the steps 301 and thereafter are repeated.

When the connection of the external apparatus is detected at the step 301, the controller 21 obtains the identification data on the connected external apparatus from the external apparatus connection detection/identification unit 26, and reads the number of the telephone to which a call is to be transferred corresponding to the connected external apparatus from the memory 24 (step 303). The controller 21 then automatically executes the ‘transferred telephone registration’ process in accordance with the procedure shown in FIG. 18 (step 304).

After the end of the ‘transferred telephone registration’ process, the controller automatically executes the ‘transfer start’ process in accordance with the procedure shown in FIG. 18 (step 305), and the process is returned to the start. In this manner, the calls reached to the mobile telephone thereafter are transferred to the telephone to which a call is to be transferred.

On the other hand, if the external apparatus connection detection/identification unit 26 detects that no external apparatus is connected at the step 302, the controller 21 assumes that the special service code for ‘transfer stop’ has been input, and automatically executes the ‘transfer stop’ process in accordance with the procedure shown in FIG. 18 (step 306), and the process is returned to the start. The transfer service is stopped thereafter.

In this manner, if the first external apparatus 12₁ (FIG. 5) is adopted as the battery charger for the telephone at home and the number of the home phone is stored in correspondence with the first external apparatus 12₁, while the second external apparatus 12₂ is adopted as the battery charger for the telephone in the office and the number of the telephone in the office is stored in correspondence with the second external apparatus 12₂, it is possible to instruct the start of the call transfer service to the fixed telephone at home only by mounting the mobile telephone 11 on the battery charger for the home telephone, and the start of the call transfer service to the fixed telephone in the office only by mounting the mobile telephone 11 on the battery charger for the telephone in the office. It is also possible to stop the transfer service only by removing the mobile telephone 11 from the battery charger.

### (e) Modification

In the second embodiment described above, the correspondence between each external apparatus and the number of the telephone to which a call is to be transferred is stored in the memory of the mobile telephone.

Alternatively, it is possible to adopt the structure in which the number of the telephone to which a call is to be transferred is stored in a memory of each external apparatus and the number of the telephone to which a call is to be transferred is obtained from the connected external apparatus when executing the ‘transferred telephone registration’ process.

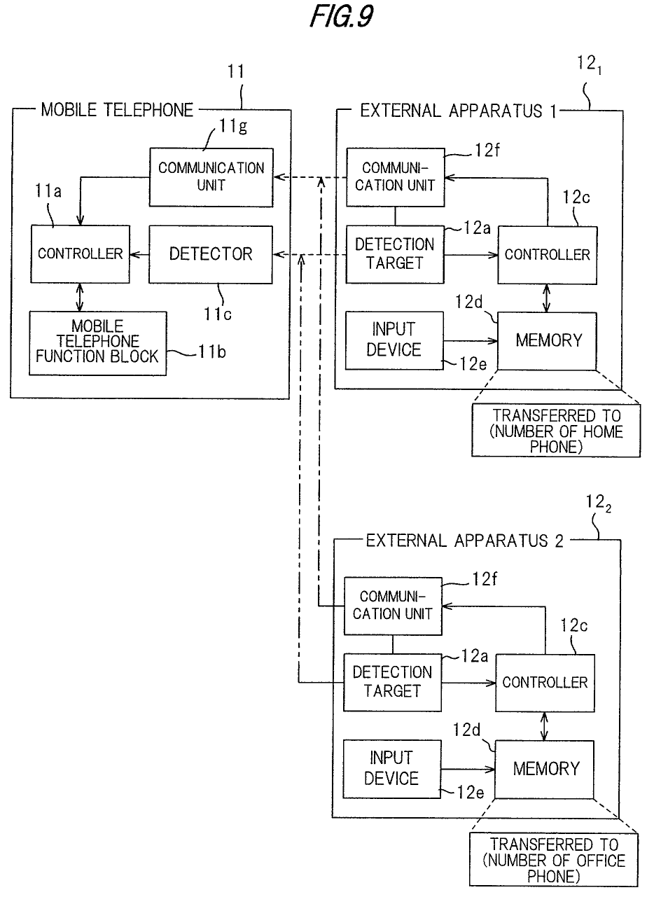

FIG. 9 shows the structure of a modification of the second embodiment. In FIG. 9, the reference numeral 11 represents a mobile telephone, and 12₁, 12₂ first and second external apparatuses such as battery chargers connected to the mobile telephone 11. In the mobile telephone 11, the reference numeral 11a represents a controller, 11b a block provided with the function of a conventional mobile telephone, 11c a detector for detecting whether or not an external apparatus is connected, and 11g a communication unit for communicating with a connected external apparatus and obtaining the number of the telephone to which a call is to be transferred from the connected external apparatus. In each of the first and second external apparatuses 12₁, 12₂, the reference numeral 12a represents a detection target for making the detector 11c detect the connection of the external apparatus 12₁ (12₂), 12c a controller for controlling the external apparatus 12₁ (12₂), 12d a memory for storing the number of the telephone to which a call is to be transferred corresponding to its own external apparatus, 12e an input device for inputting the number of the telephone to which a call is to be transferred, to the memory 12d, and 12f a communication unit for communicating with the communication unit 11g of the mobile telephone 11 so as to transmit the number of the telephone to which a call is to be transferred, to the mobile telephone.

When the first or second external apparatus 12₁ or 12₂ is connected to the mobile telephone 11, the controller 11a detects that the external apparatus is connected by the cooperation of the detector 11c and the detection target 12a, and the controller 12c of the external apparatus detects that the mobile telephone 11 is connected to the external apparatus. The controller 12c of the external apparatus reads the number of the telephone to which a call is to be transferred from the memory 12d, and transmits the telephone number to the controller 11a of the mobile telephone 11 via the communication units 12f, 11g. The controller 11a which has received the number of the telephone to which a call is to be transferred automatically executes the procedure for ‘transferred telephone registration’ and ‘transfer start’ by controlling the block 11b having the function of the conventional mobile telephone in accordance with the procedure shown in FIG. 18. When the mobile telephone 11 is removed from the external apparatus 12₁ or 12₂, the controller 11a detects that the external apparatus has been removed by the cooperation of the detector 11c and the detection target 12a, and automatically executes the procedure for ‘transfer stop’ by controlling the block 11b having the function of the conventional mobile telephone in accordance with the procedure shown in FIG. 18.

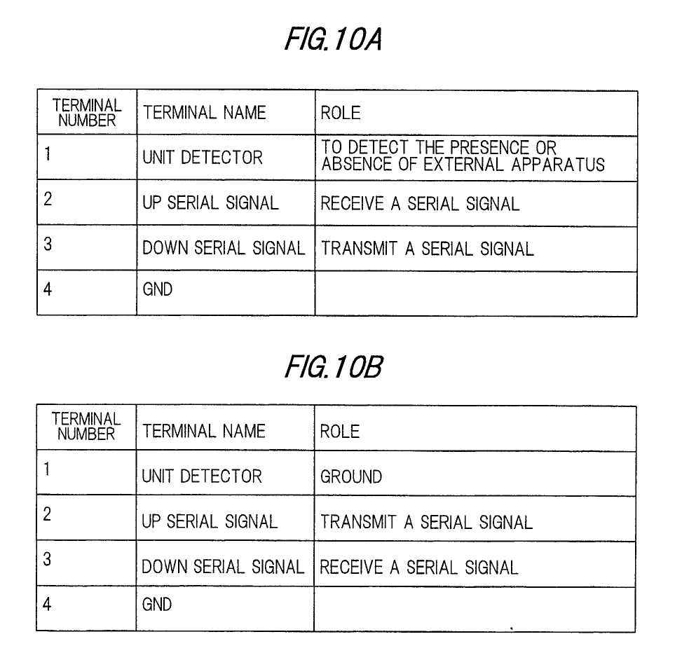

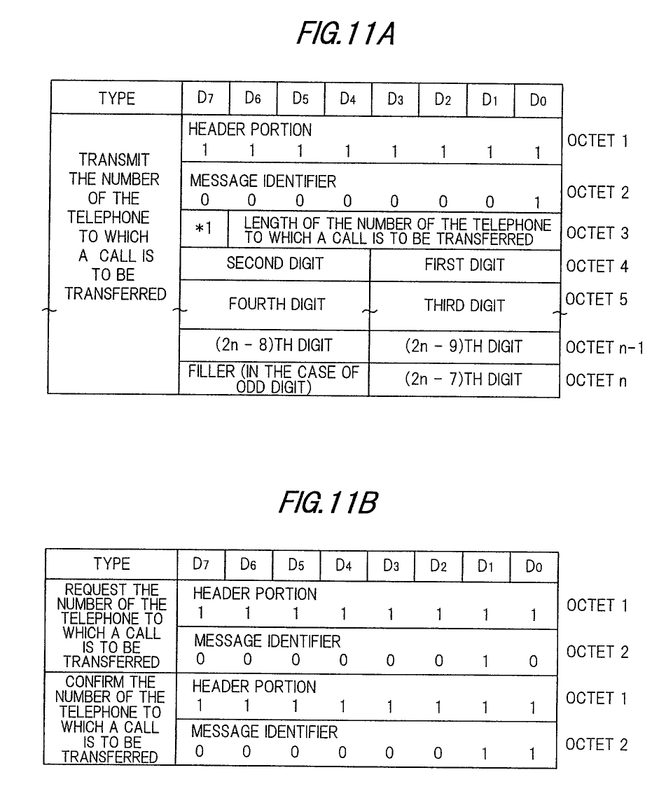

FIGS. 10A and 10B are explanatory views of communication interfaces between a mobile telephone and an external apparatus, wherein FIG. 10A shows the interface of the communication unit 11g of the mobile telephone, and FIG. 10B shows the interface of the communication unit 12f of the external apparatus. When the mobile telephone 11 is connected to the external apparatus 12₁ (12₂), the terminals having the same number are connected with each other. As a result, it is possible to detect the connection or disconnection of an external apparatus by judging whether or not the terminal voltage of the terminals having number 1 has the ground level. In other words, if neither of the external apparatuses 12₁ (12₂) is connected, the terminals 1 are released. On the other hand, when the external apparatus 12₁ (12₂) is connected, the terminals 1 are grounded. The controller 11a of the mobile telephone 11 detects the connection or disconnection of an external apparatus from the difference in the impedance. The mobile telephone 11 and the external apparatus 12₁ (12₂) serially transmit and receive signals by using the terminals having numbers 2 and 3.

FIGS. 11A and 11B are explanatory views of the formats of serial signals, wherein FIG. 11A shows the format of an up serial signal, and FIG. 11B the format of a down serial signal. Each signal is identified by a header portion and a message identifier.

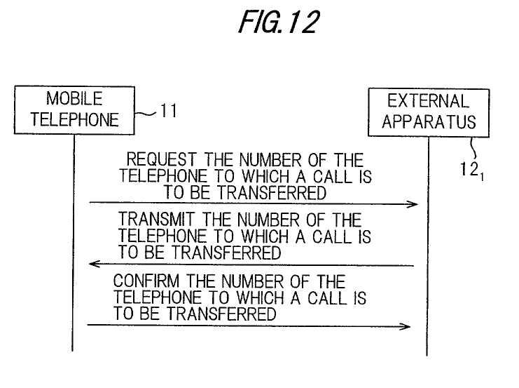

FIG. 12 shows the communication sequence between a mobile telephone and an external apparatus when the mobile telephone 11 is connected to the external apparatus 12₁ (12₂). When the controller 11a of the mobile telephone 11 detects that the external apparatus 12₁ is connected to the mobile telephone 11, the controller 11a transmits the message requesting the number of the telephone to which a call is to be transferred, to the external apparatus 12₁ via the communication unit 11g. The controller 12c of the external apparatus 12₁ reads the number of the telephone to which a call is to be transferred from the memory 12d, and transmits the number to the controller 11a of the mobile telephone 11 via the communication unit 12f. The controller 11a of the mobile telephone 11 which has received the number of the telephone to which a call is to be transferred automatically executes the procedure for ‘transferred telephone registration’ and ‘transfer start’ by controlling the block 11b having the function of the conventional mobile telephone in accordance with the procedure shown in FIG. 18. When the mobile telephone 11 is removed from the external apparatus 12₁ or 12₂, the controller 11a detects that the external apparatus has been removed by the cooperation of the detector 11c and the detection target 12a, and automatically executes the procedure for ‘transfer stop’ by controlling the block 11b having the function of the conventional mobile telephone in accordance with the procedure shown in FIG. 18.

As explained above, if the first external apparatus 12₁ is adopted as the battery charger for the telephone at home and the number of the home phone is stored in correspondence with the first external apparatus 12₁, while the second external apparatus 12₂ is adopted as the battery charger for the telephone in the office and the number of the telephone in the office is stored in correspondence with the second external apparatus 12₂, it is possible to instruct the start of the call transfer service to the fixed telephone at home only by mounting the mobile telephone 11 on the battery charger for the home telephone, and the start of the call transfer service to the fixed telephone in the office only by mounting the mobile telephone 11 on the battery charger for the telephone in the office. It is also possible to stop the transfer service only by removing the mobile telephone 11 from the battery charger.

General digital mobile telephones have interfaces for connecting adapters for facsimile communication and modem communication thereto. Such an interface is usable as an interface between a mobile telephone and an external apparatus. Although cable connection is adopted in the above examples, connection using an infrared interface may be possible.

### (C) Third Embodiment

### (a) Summary

In a third embodiment, an external apparatus is connected to a public telecommunication network, and when the mobile telephone is connected to the external apparatus, the mobile telephone automatically executes the procedure for ‘transfer start’ if the communication between the mobile telephone and the mobile communication network is possible. On the other hand, if the communication between the mobile telephone and the mobile communication network is impossible, the mobile telephone requests the external apparatus to execute the procedure for ‘transfer start’, whereby the external apparatus automatically executes the procedure for ‘transfer start’. When the mobile telephone is removed from the external apparatus, the external apparatus automatically executes the procedure for ‘transfer stop’. In this manner, even if the mobile telephone cannot be used because of the location outside of the service area or due to the regulation on radio waves, it is possible to talk with the caller via the fixed telephone to which the call is transferred when a call is received by the mobile telephone.

### (b) Structure

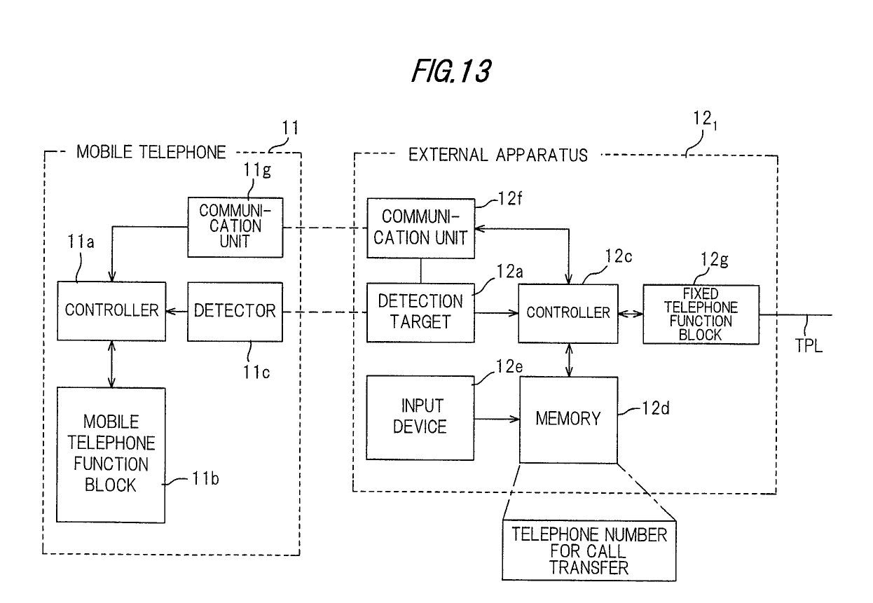

FIG. 13 shows the structure of the third embodiment, wherein the same reference numerals are provided for the elements which are the same as those in the modification of the second embodiment shown in FIG. 9. This embodiment is different from the modification shown in FIG. 9 in that the external apparatus 12₁ has a block 12g having a function of a fixed telephone which realizes the connection with the public telecommunication network.

When the external apparatus 12₁ is connected to the mobile telephone 11, the controller 11a receives the number of the telephone to which a call is to be transferred from the external apparatus 12₁ in the same way as in the modification shown in FIG. 9, and automatically executes the procedure for ‘transferred telephone registration’ and ‘transfer start’ by controlling the block 11b having the function of the conventional mobile telephone in accordance with the procedure shown in FIG. 18. When the mobile telephone 11 is removed from the external apparatus 12₁, the controller 11a of the mobile telephone 11 automatically executes the procedure for ‘transfer stop’ by controlling the block 11b having the function of the conventional mobile telephone.

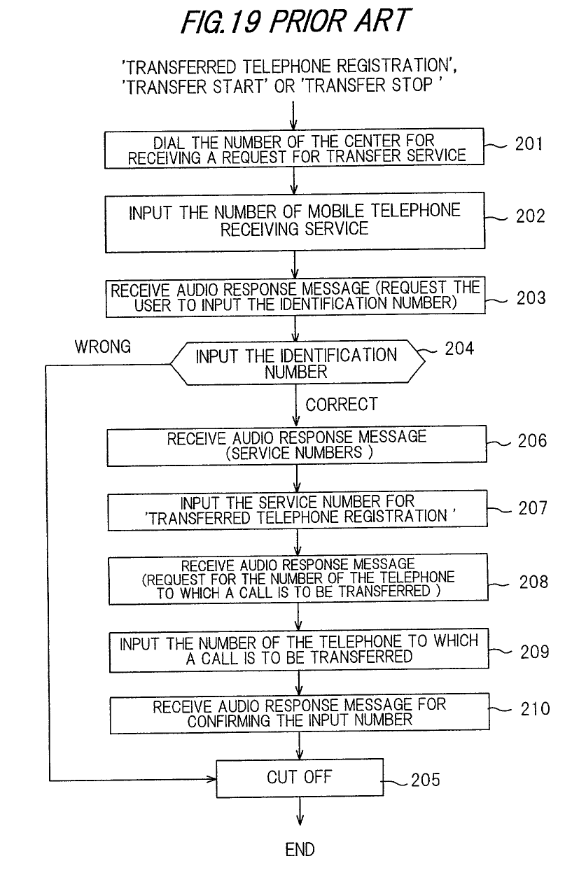

On the other hand, if the mobile telephone cannot execute the procedure for ‘transferred telephone registration’ and ‘transfer start’ because of the location outside of the service area or due to the regulation on radio waves, the controller 11a of the mobile telephone 11 requests the controller 12c of the external apparatus 12₁ to execute the procedure. The controller 12c of the external apparatus 12₁ then automatically executes the procedure for ‘transferred telephone registration’ and ‘transfer start’ by controlling the block 12g having the function of a fixed telephone and by using the public telecommunication network in accordance with the procedure shown in FIG. 19. When the mobile telephone 11 is removed from the external apparatus 12₁, the controller 12c of the external apparatus 12₁ automatically executes the procedure for ‘transfer stop’ by controlling the block 12g having the function of a fixed telephone.

### (c) ‘Transferred Telephone Registration’, ‘Transfer Start’ and ‘Transfer Stop’ Processes

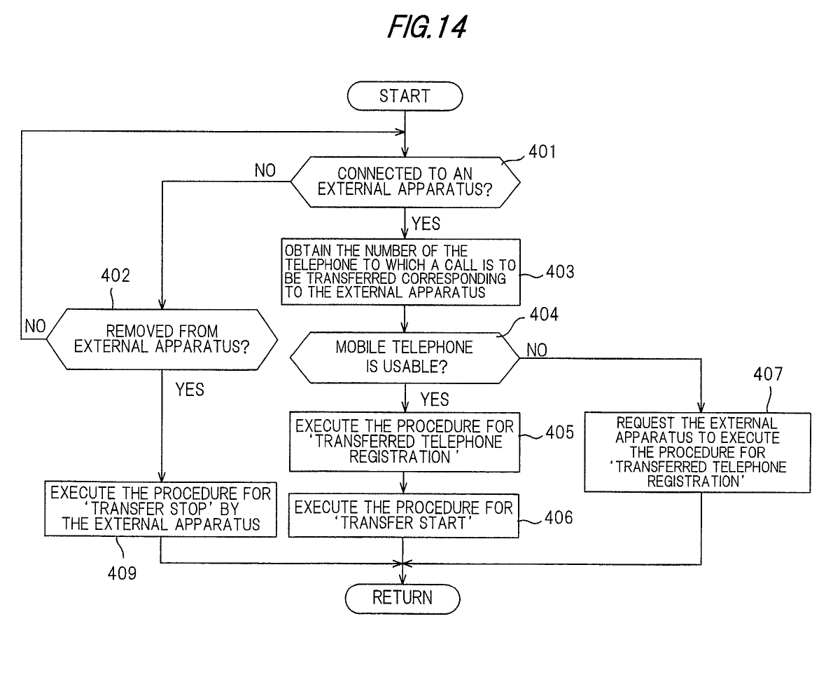

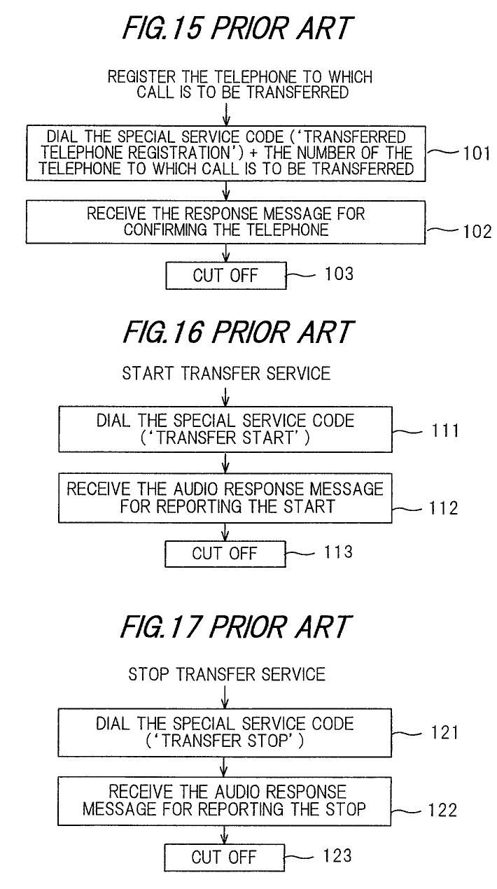

FIG. 14 is a flowchart of the ‘transferred telephone registration’, ‘transfer start’ and ‘transfer stop’ processes of the third embodiment.

The controller 11a checks whether or not the external apparatus 12₁ is connected to the mobile telephone 11 (step 401), and if the external apparatus 12₁ is not connected, whether or not the external apparatus 12₁ has been removed is checked (step 402). If the external apparatus 12₁ has not been removed, the steps 401 and thereafter are repeated. When the connection of the external apparatus 12₁ is detected at the step 401, the controller 11a obtains the number of the telephone to which a call is to be transferred from the external apparatus 12₁ (step 403). Whether or not the mobile telephone 11 is usable is then checked (step 404), and if the answer is in the affirmative, the controller 11a automatically executes the ‘transferred telephone registration’ process in accordance with the procedure shown in FIG. 18 (step 405). The controller 11a then automatically executes the procedure for the ‘transfer start’ process in accordance with the procedure shown in FIG. 18 (step 406), and the process is returned to the start. In this manner, the calls reached to the mobile telephone 11 thereafter are transferred to the telephone to which a call is to be transferred.

On the other hand, if the mobile telephone 11 is unusable at the step 404, the controller 11a requests the controller 12c of the external apparatus 12₁ to execute the procedure via the communication units 11g, 12f (a 407). The controller 12c of the external apparatus 12₁ then automatically executes the procedure for ‘transferred telephone registration’ and ‘transfer start’ by controlling the block 12g having the function of a fixed telephone and by using the public telecommunication network in accordance with the procedure shown in FIG. 19.

When the mobile telephone 11 is removed from the external apparatus 12₁ at the step 402, the controller 12c of the external apparatus 12₁ automatically executes the procedure for ‘transfer stop’ by controlling the block 12g having the function of a fixed telephone and by using the public telecommunication network in accordance with the procedure shown in FIG. 19 (step 409).

In this manner, even if the mobile telephone cannot be used because of the location outside of the service area or due to the regulation on radio waves, it is possible to register the telephone to which a call is to be transferred or execute the procedure for starting the transfer service. Therefore, it is possible to receive a call from a calling party by the registered fixed telephone when the call is reached to the mobile telephone.

Although the block 12g having the function of a fixed telephone is provided in the external apparatus 12₁ in FIG. 13, it is also possible to adopt the structure in which block 12g is not provided in the external apparatus 12₁ and the controller 12c of the external apparatus 12₁ is connected to a fixed telephone in the public telecommunication network.

As explained above, according to the present invention, it is possible to automatically start the transfer service to a predetermined telephone to which a call is to be transferred by connecting a mobile telephone and an external apparatus, and automatically stop the transfer service by removing the mobile telephone from the external apparatus. It is therefore possible to save the user the trouble of registering the telephone to which a call is to be transferred or executing the procedure for starting or stopping the transfer service. In addition, the possibility of forgetting the operation of starting or stopping the transfer service is precluded. Especially, if the battery charger of the mobile telephone is adopted as the external apparatus, it is possible to start the call transfer service only by mounting the mobile telephone on the battery charger, and stop the service only by removing the mobile telephone from the battery charger.

According to the present invention, if a plurality of external apparatuses are prepared and any given one is connected to the mobile telephone, it is possible to register a telephone to which a call is to be transferred corresponding to the connected external apparatus and execute the procedure for starting the transfer service. If the external apparatus is removed from the mobile telephone, it is possible to automatically execute the procedure for stopping the transfer service. In other words, according to the present invention, it is easy to change the telephone to which a call is to be transferred and to start or stop the call transfer service thereto.

In addition, according to the present invention, if the battery charger of the mobile telephone is adopted as the external apparatus, it is possible to start the transfer service to the fixed telephone at home only by mounting the mobile telephone on the battery charger at home or to the fixed telephone in the office only by mounting the mobile telephone on the battery charger in the office, and stop the transfer service only by removing the mobile telephone from the battery charger.

Furthermore, according to the present invention, if the mobile telephone is not communicable to the mobile communication network when the external apparatus is connected to the mobile telephone, the mobile telephone requests the external apparatus to execute the procedure for starting the transfer service, and the external apparatus executes the procedure via the public telecommunication network. When the connection between the mobile telephone and the external apparatus is cut off, the external apparatus executes the procedure for stopping the transfer service. It is therefore possible to register a telephone to which a call is to be transferred or execute the procedure for starting the transfer service, even if the mobile telephone cannot be used because of the location outside of the service area or due to the regulation on radio waves, and it is possible to receive a call from a calling party by the registered fixed telephone when the call is reached to the mobile telephone.

According to the present invention, it is unnecessary to add an equipment or changing the call transfer system on the network side and it is possible to prevent an increase in the traffic in the radio circuit.

As many apparently widely different embodiments of the present invention can be made without departing from the spirit and scope thereof, it is to be understood that the invention is not limited to the specific embodiments thereof except as defined in the appended claims.

What is claimed is:

1. A mobile telephone having a call transfer function for transferring a received call to a telephone designated in advance, said mobile telephone comprising:
a detector for detecting that an external apparatus is connected to said mobile telephone; and
a call transfer controller for requesting a mobile communication network to start a call transfer service for transferring said received call to said designated telephone when said external apparatus is connected.

2. A mobile telephone according to claim 1, further comprising:
a memory for storing the telephone number of said telephone to which a call is to be transferred, wherein said call transfer controller obtains said telephone number from said memory.

3. A mobile telephone according to claim 1, further comprising:
a means for obtaining the telephone number of said telephone to which a call is to be transferred and which is stored in a memory of said external apparatus, wherein said call transfer controller obtains said telephone number via said means.

4. A mobile telephone according to claim 1, wherein said detector detects that the connection between said mobile telephone and said external apparatus is cut off, and said call transfer controller requests said mobile communication network to stop said call transfer service when said connection is cut off.

5. A mobile telephone according to claim 1, wherein said external apparatus is a battery charger for said mobile telephone.

6. A mobile telephone having a call transfer function for transferring a received call to a telephone designated in advance, said mobile telephone comprising:
an external apparatus identification unit for identifying an external apparatus which is connected to said mobile telephone; and
a call transfer controller for identifying a telephone corresponding to said external apparatus when said the external apparatus is connected, and requesting a mobile communication network to start a call transfer service for transferring said received call to said identified telephone.

7. A mobile telephone according to claim 6, further comprising:
a memory for storing telephone number of a telephone to which a call is to be transferred in correspondence with said external apparatus, wherein said call transfer controller obtains said telephone number corresponding to said connected external apparatus from said memory.

8. A mobile telephone according to claim 6, wherein said call transfer controller requests said mobile communication network to stop said call transfer service when the connection between said mobile telephone and said external apparatus is cut off.

9. A mobile telephone according to claim 6, wherein said external apparatus is a battery charger for said mobile telephone.

10. A call transfer method by a mobile telephone for transferring a received call to a telephone designated in advance, said method comprising the steps of:
registering a telephone to which a call is to be transferred in a memory; and
requesting a mobile communication network to start a call transfer service for transferring a received call to said registered telephone when an external apparatus is connected to said mobile telephone.

11. A call transfer method by a mobile telephone according to claim 10, further comprising of the step of:
obtaining telephone number of said registered telephone from said external apparatus in a case where said telephone number is stored in a memory of said external apparatus.

12. A call transfer method by a mobile telephone according to claim 10, further comprising the steps of:
registering a telephone to which a call is to be transferred, in a memory in correspondence with an external apparatus;
identifying an external apparatus connected to said mobile telephone;
obtaining a telephone which is registered in said memory in correspondence with said connected external apparatus; and
requesting said mobile communication network to start said call transfer service.

13. A call transfer method by a mobile telephone according to claim 10, further comprising the step of:
requesting said mobile communication network to stop said call transfer service when the connection between said mobile telephone and said external apparatus is cut off.

14. A call transfer method by a mobile telephone for transferring a received call to a telephone designated in advance, said method comprising the steps of:
registering a telephone to which a call is to be transferred;
requesting the mobile communication network to start a call transfer service for transferring a received call to said designated telephone when an external apparatus is connected to said mobile telephone, if said mobile telephone is communicable to said mobile communication network; and
requesting said external apparatus to execute the procedure for starting said call transfer service when said external apparatus is connected to said mobile telephone, if said mobile telephone is not communicable to said mobile communication network, whereby said external apparatus requests said mobile communication network to start said call transfer service.

15. A call transfer method by a mobile telephone according to claim 14, wherein said external apparatus requests said mobile communication network to stop said call transfer service when the connection between said mobile telephone and said external apparatus is cut off.
